(19) United States
(12) Patent Application Publication
(10) Pub. No.: US 2007/0005267 A1
(43) Pub. Date: Jan. 4, 2007

(54) Mobile communication device with gas detecting function

(75) Inventor: Nien-Yen Li, Taipei (TW)

Correspondence Address: BRUCE H. TROXELL, SUITE 1404, 5205 LEESBURG PIKE, FALLS CHURCH, VA, 22041, US

(73) Assignee: Inventec Appliances Corp.

(21) Appl. No.: 11/158,066

(22) Filed: Jun. 22, 2005

(51) Int. Cl. G01M 19/00

(52) U.S. Cl. 702/24; 702/122

(57) ABSTRACT

A mobile communication device with gas detecting function can detect the quality of air and immediately transfer air condition data to some remote database. The mobile communication device comprises a mobile communication module and a gas detector. The mobile communication module further comprises a communication interface, a microprocessor, and a memory. The communication interface is used for bi-directional data-transferring. The microprocessor coupling to the communication interface is used for data processing in the mobile communication device. The memory connecting to the microprocessor is used for saving data from the microprocessor and providing data to the microprocessor.

### BACKGROUND OF THE INVENTION

(1) Field of the Invention

The invention relates to a mobile communication device, and more particularly to a mobile communication device with gas detecting function, which can detect the quality of air and simultaneously transfer air condition data to a remote database.

(2) Description of the Prior Art

There's a lot of methods and equipments to detect gas quality already in the marketplace. In early periods, miners and soldiers used canaries to detect poison gas. In a later time, the bird was not used to detect the air anymore, but various substitute detecting means are introduced to monitor the air quality. These detecting means include chemical adsorbers, electrical sensors, galvanic cell sensors, gas chromatography sensors, mass spectrometers and so on. Some of the detecting means may only aim at a respective particular environment or a particular kind of poison gas.

Since 1964, application of semiconductors (such as tin oxides and zirconia) as air sensors becomes popular, due to the lower prices and longer tolerance times. It is interesting to note that almost all the flammable CO sensors are made of semiconductors in sensor market. A characteristic of semiconductor material is that its conductivity is between that of the conductor and that of the nonconductor. In the case that a poison air flows over the surface of a particular semiconductor substrate, some kind of adsorption reaction can cause a characteristic change in the substrate. For example, the change may be the conductivity of the semiconductor. Though the semiconductor can be used to judge the concentration of the pass-by air, yet temperature sensibility and power consumption keep away the semiconductor sensor from an acceptable mobile sensor.

An optics gas analyzer based on an infrared light can be seen in the market. Additionally, double-beam or multi-beam optics gas sensors are also available to detect various kinds of poison gas. The infrared sensor, characterized in distant or non-contact detection and well known in analyzing hydrocarbons, is usually applied to monitor the environmental smoke. However, the large-in-size infrared sensor is also irrelevant to be a portable gas monitor.

Recently, nano-technology is hot in various manifolds. Ashish Modi develops a detector based on nanotubes. The basic structure of this detector is a nanotube array which is arranged on a silicon dioxide substrate. The radius of a tip side of each nanotube is only 15 nm, and adjacent nanotubes are distanced 50 nm away from each other. An aluminum electrode is located above each respective nanotube at about a 150-μm spacing. The electric field around the shrill nanotube is thus strong enough to ionize surrounding gas molecules so as to establish an electric connection between adjacent nanotubes. It is well known in the art that breakdown voltages for different gases are different. Therefore, the breakage voltage can be used to judge the type of the gas molecules surrounding the nanotube. Empirically, an exponential function can be found to define the relationship between the induced current and the gas concentration, and therefore quantitative analysis based on the value of current can be carried out to located the surrounding gas molecules. The work voltage of the nanotube is very low. For example, it takes 130V for a nanotube detector with 25 μm between electrodes to ionize the surrounding gas molecule. Such kind of voltage level can be simply provided by a normal battery in the market, and thus it may make the mobile gas detector much feasible.

As stated, a lot of difficulties exist in developing a mobile gas detector. Except for the work voltage to be overcome, the type of target gas is also another concern. Basically, one detector is usually designed to locate a single type of poison gas. However, more than one type of poison gas might exist in one work area. Therefore, how to detect more than one type of poison gas quickly in a single device is yet an problem to be resolved. Though some large-scale infrared detectors are already developed to detect several kinds of pollution gases at the same time, yet the cost and the volume of the large-scale infrared detectors make them unpopular. On the other hand, the management of air condition data and the communication between the detection site and the remote database are also crucial.

### SUMMARY OF THE INVENTION

Accordingly, it is a primary object of the present invention to provide a mobile communication device, which can detect the quality of air and immediately transfer air condition data to some remote database.

The second object of the present invention is to provide a mobile communication device which can connect a gas detector, which can switch conveniently the type of the target gas while facing various kind of gases.

A mobile communication device with gas detecting function in accordance with the present invention, which can detect the quality of air and immediately transfer air condition data to some remote database, comprises a mobile communication module and a gas detector. The mobile communication module further comprises a communication interface, a microprocessor, and a memory. The communication interface is used for bi-directional data transferring. The microprocessor coupling to the communication interface is used for operating, calculating, and processing all data in the mobile communication device. The memory connecting to the microprocessor is used for saving data sent from the microprocessor and providing data to the microprocessor.

### BRIEF DESCRIPTION OF THE DRAWINGS

The present invention will now be specified with reference to its preferred embodiment illustrated in the drawings, in which

FIG. 1 is a structure diagram of a first embodiment of the invention;

FIG. 2 is a structure diagram of a second embodiment of the invention; and

FIG. 3 is a structure diagram of a third embodiment of the invention.

### DESCRIPTION OF THE PREFERRED EMBODIMENT

The invention disclosed herein is directed to an mobile communication device. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

In the following description, elements that have the same function but slight different shapes will be labeled by the same number and identical name so as to ensure overall consistency.

The invention aims at providing a mobile communication device, and more particularly to a mobile communication device with gas detecting function, which can detect the quality of air and immediately transfer air condition data to some remote database.

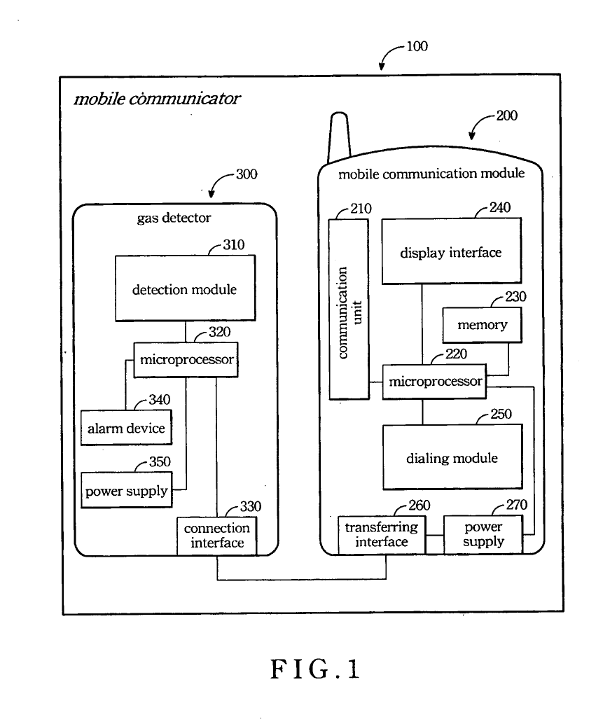

Referring to FIG. 1, a schematic diagram of a first embodiment of the invention is shown. The mobile communication device 100 includes a mobile communication module 200 and a gas detector 300. The mobile communication module 200 further comprises a communication unit 210, which can receive signals from some remote database via a wireless internet or a broadcast system. After decoding the signal to data, the communication unit 210 can transfer the data to a microprocessor 220 for further calculating the data. The communication unit 210 can also transfer the data from the microprocessor 220 to some remote database via a wireless internet or a broad system. Upon such an arrangement, a dual-communication mode can be formed.

The communication links available for the present invention can be a GSM, a CDMA, a PHS, or a two-way communication link. The microprocessor 220 connects to a memory 230 that can extract the data or an application program from the memory 230 and save the foreigner and processed data into the memory 230. A user can read all the messages processed by the microprocessor 210 via a display interface 240, and can process other inputs through a dialing module 250. In addition, the communication module can further comprise a transferring interface 260, which can be a connecting port of the detector 300 and can transfer the data from the detector 300 to the microprocessor 220.

The mobile communication device 100 can further comprise a power supply 270, which connects to the mobile communication module 200 and provides electricity to the mobile communication device. The power supply 270 can comprise a DC adaptor and a battery module. The DC adaptor can connect to an AC power supply for power supplying, or to a lithium ion battery for such power supplying. Moreover, a charging circuit and related programs can be embedded in the microprocessor 320 for handling the recharging of the lithium ion battery.

The gas detector 300 comprises a detection module 310, a microprocessor 320, a connection interface 330, and an alarm device 340. The microprocessor 320 connects to the gas detection module 310, which can calculate and read the data from the gas detection module 310 and can also transfer the data to the mobile communication module 200 via the connection interface 330 so as to show the air condition data on the display interface 240. The user can transfer air condition data to some remote database via the mobile communication module, 200. Additionally, the microprocessor 320 includes a trigger program. While the data is judged by the microprocessor 320 to be higher than a predetermined value, the trigger program can activate the alarm device 340 to warn the user and can also transfer the warning data via the connection interface 330 and further the mobile communication module 200 to some remote database. The gas detector 300 furthermore comprises a power supply 350 to support power for operation.

The mobile communication module 200 of the present invention can be a digital assisting tool, such a PDA or a mobile phone. While connecting the gas detector 300, the digital assisting tool can receive the data via the transferring interface 260 and transfer the data to some remote database. The remote database of the present invention can be various. In one embodiment, the remote database can be a gas monitoring data bank in an environmental protection section. In another embodiment, the remote database can be a crime-watch data bank, which can use the air condition data to determine the alcohol concentration of a driver. In a further embodiment, the remote database can be a community safety system that can use the present invention to monitor the concentration of CO in the atmosphere. Based on different demands, that the invention can transfer data to the respective remote database is one characteristic of the mobile communication device 100.

In the invention, the gas detector 300 can be a semiconductor detector, an infrared detector, or a nanotube detector. Presently, most of the exhaust gas detectors are usually constructed on the road having heavy traffic. To meet various and quick environmental change on road such as vehicle speed, temperature change, wind speed, and spreading of the exhaust gas, the mobile communication device can download the environmental calibration factors form a distance data bank for calibrating the gas detector 300. With the characteristics of portability and communication ability, the mobile communication device 100 can get a higher degree of accuracy while in monitoring the gas quality.

Traditionally, gas quality control is usually evaluated by referring to an index gas. For example, the hydrogen can be used as the index gas. However, a certain bias can be expected if the same index gas is used to quantify the exhaust gas from different pollution sources. On the other hand, for the gas detector 300 is simply cabled to the mobile communication module 200, it would be quite easy for the mobile communication device 100 of the present invention to replace a suitable gas detector 300 that meets the possible composition of the exhaust gas in the detection site.

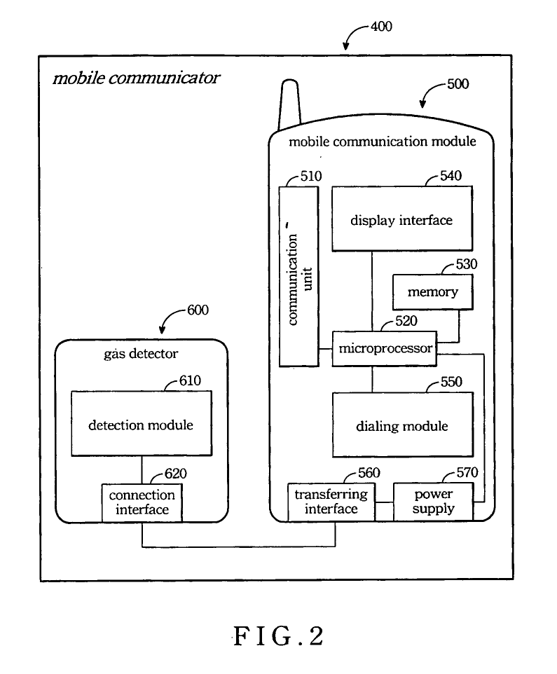

Referring to FIG. 2, a schematic diagram of a second embodiment of the invention is shown. The mobile communication device 400 includes a mobile communication module 500 and a gas detector 600. The mobile communication module 500 further comprises a communication unit 510, in a way similar to the first embodiment, which can receive signals from some remote database via a wireless internet or a broadcast system. After decoding the signals into data, the communication unit 510 can transfer the data to a microprocessor 520 for further calculating the data. The communication unit 510 can also transfer the data from the microprocessor 520 to some remote database via the wireless internet or the broad system. Therefore, a dual-communication mode is formed.

The microprocessor 520 connects to a memory 530, from which the microprocessor 520 can extract the data or application programs. Also, foreign and processed data can be stored into the memory 530. The user can read all the messages processed by the microprocessor 510 via a display interface 540, and a dialing module 550 can be included to process dialing and other input process.

The gas detector 600 comprises a detection module 610 to monitor specific kind of gas, and a connection interface 620 connecting to the interface 560 of mobile communication module 500 for transferring the air condition data into the microprocessor 520 for further calculating.

The mobile communication device 400 further comprises a power supply 570. Like the first embodiment, the power supply 570 can comprise a DC adaptor and a battery module.

The gas detector 600 is a substitute accessory to the mobile communication device 400, so that the type of the gas detector 600 to go with the mobile communication module 500 can be wisely chosen to meet concurrent requirements. Through the mobile communication module 500, update programs can be arbitrarily and wireless obtained so as to get a better detection.

In an embodiment of the invention, an alcohol detector 600 can be connected to the mobile communication device 400 for a public security purpose. The alcohol detector may be an electrochemical sensor, a semiconductor sensor, or a nanotube sensor. The police can use the mobile communication device 400 to detect the alcohol concentration of the driver. Also, the police can transfer the vehicle identification number and the driver license number to the police data bank via the mobile communication device for simultaneously checking if the car or the driver has any criminal record. Also, the testing result of the alcohol concentration can be forwarded to the police station via the mobile communication module 500.

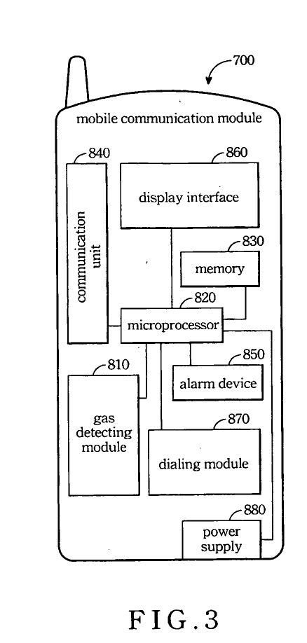

Referring to FIG. 3, a schematic diagram of a third embodiment of the invention is shown. The mobile communication device 700 includes a gas detecting module 810, a microprocessor 820, a memory 830, a communication unit 840, an warning device 850, a display interface 860, and a dialing module 870. The microprocessor 820 is used for reading and calculating the data transferred from the gas detecting module 810. The warning device 850 connects to the microprocessor 820. While the data detected is over a predetermined value, the microprocessor 820 will alarm the user via the warning device 850. Like two foregoing embodiments, the operating state of the mobile communication device can be read through the display interface 860, and the user can input data to the mobile communication device through the dialing module 870.

The microprocessor 520 connects to a memory 530 for storing data and application programs. The user can read all the messages processed by the microprocessor 510 via a display interface 540, and can use a dialing module 550 to process dialing and other input requirements.

The mobile communication device 700 further comprises a power supply 880 connecting to the mobile communication module 800 for providing the electric power. The power supply 880 comprises a DC adaptor and a battery module. The DC adaptor can connect to an AC power supply, and the battery module can be a lithium ion battery. Also,, a charging circuit and related programs can be embedded in the microprocessor 820 for recharging the battery module.

While the concentration of the detected gas is over the tolerance range, the microprocessor 820 will use the warning device 850 to warn the user.

In one embodiment of the invention, the mobile communication device can used for detecting carbon monoxide(CO). It is always the news that a carbon monoxide poisoning occurs in a household. The CO is colorless and tasteless, but lethally. While people is in a house, he/she can switch the gas detector 810 on, and use it for monitoring the concentration of the CO inside the house. The microprocessor will activate the warning device 850 if the CO concentration is over the predetermined value. In particular, if the warning device alarms over a period of time previously set by the user and no one pushes a stop button to end the alarm, the microprocessor 820 can use automatically the dialing module 870 to dial a SOS number that can be set in the memory 830 in advance to notify a concerned third party, the police for example.

In addition, the mobile communication device can also be used in the scene of a fire. A firefighter can take the mobile communication device with him/her so as to communicate with other firefighters by broadcasting the concentration of CO or other poison gas around him/her. Then, the safety of the entire firefighting crew against the poison gases can be increased.

While the present invention has been particularly shown and described with reference to a preferred embodiment, it will be understood by those skilled in the art that various changes in form and detail may be without departing from the spirit and scope of the present invention.

What is claimed is:

1. A mobile communication device, comprising:
a mobile communication module ; and
a gas detector connecting to the mobile communication module, monitoring an air condition, generating air condition data according to the air condition, and transferring the air condition data to the mobile communication module, wherein the mobile communication module sends the air condition data to a remote database and receives information from the remote database.

2. The mobile communication device according to claim 1, wherein the mobile communication module further comprising further comprising:
a communication interface for transferring and receiving signals from the remote database;
a microprocessor coupling to the communication interface for processing all the data in the mobile communication device;
a memory connecting to the microprocessor for saving data from the microprocessor and providing data to the microprocessor;
a display interface coupling to the microprocessor for displaying a state of the mobile communication device; and
a dialing module coupling to the microprocessor for accepting a dialing input.

3. The mobile communication device according to claim 1, wherein the mobile communication device further comprises an alarm device coupling to the microprocessor for warning a user while the air condition data is higher than a predetermined value.

4. The mobile communication device according to claim 1, wherein the gas detector is selected from a group of a semiconductor gas sensor, a nanotube gas sensor, an infrared gas sensor, and an electrochemical gas sensor.

5. The mobile communication device according to claim 1, wherein the communication interface is an interface having a communication protocol selected from a group of a GSM, a CDMA, a PHS, and a dual-mode communicating protocol.

6. The mobile communication device according to claim 1, wherein the update data is a data related to temperature and humidity.

7. The mobile communication device according to claim 1, wherein the gas detector is formed as a replaceable accessory of the mobile communication device.

8. The mobile communication device according to claim 1, wherein the remote database is a supervisory control center.

9. A mobile communication device, comprising:
a communication interface for transferring and receiving bi-directional signals from remote database;
a microprocessor coupling to the communication interface for processing data in the mobile communication device; and
a gas detection module connecting to the microprocessor, used for monitoring an air condition and transferring the air condition data to the microprocessor for further data processing.

10. The mobile communication device according to claim 9, further comprising:
a memory connecting to the microprocessor for saving data from the microprocessor and providing data to the microprocessor;
a display interface coupling to the microprocessor for displaying a state of the mobile communication device; and
a dialing module coupling to the microprocessor for accepting a dialing input.

11. The mobile communication device according to claim 7, wherein the mobile communication device further comprises an alarm device coupling to the microprocessor for warning a user while the air condition data is higher than a predetermined value.

12. The mobile communication device according to claim 7, wherein the gas detector is selected from a group of a semiconductor gas sensor, a nanotube gas sensor, an infrared gas sensor, and an electrochemical gas sensor.

13. The mobile communication device according to claim 7, wherein the communication interface is an interface having a communication protocol selected from a group of a GSM, a CDMA, a PHS, and a dual-mode communicating protocol.

14. The mobile communication device according to claim 7, wherein the update data is a data related to temperature and humidity.

15. The mobile communication device according to claim 7, wherein the gas detector is formed as a replaceable accessory of the mobile communication device.
